(19) United States
(12) Patent Application Publication
(10) Pub. No.: US 2007/0006810 A1
(43) Pub. Date: Jan. 11, 2007

(54) Apparatus for protecting a vehicle from scratches and animal hair caused by and shed respectively from a pet

(76) Inventors: Danielle Dawson, Mary Esther, FL (US); Richard Dawson, Mary Esther, FL (US)

Correspondence Address: JAMES RAY & ASSOCIATES, 2640 Pitcairn Road, Monroeville, PA, 15146, US

(21) Appl. No.: 11/474,753

(22) Filed: Jun. 26, 2006

Related U.S. Application Data
(60) Provisional application No. 60/693,922, filed on Jun. 24, 2005.

(51) Int. Cl. A01K 39/00

(52) U.S. Cl. 119/51.5

(57) ABSTRACT

An apparatus for protecting a vehicle from a pet scratching and shedding hair includes a first member having each of a first predetermined shape, a first predetermined size, a first predetermined thickness and which is substantially impermeable to such pet's nails. The first member extends over such vehicle's window ledge and downwardly a predetermined distance from such vehicle window ledge which is at least sufficient to prevent such pet's nails contacting such vehicle's paint. There is a second member having each of a second predetermined shape, a second predetermined size and a second predetermined thickness for preventing at least one of such pet's hair and wet and muddy paws from contacting a seat of such vehicle. A securing device is engageable with a first predetermined edge of the first member and a first predetermined edge of the second member for securing such first member to such second member.

### CROSS REFERENCE TO RELATED APPLICATIONS

This application is closely related to and claims benefit from U.S. Provisional Application Ser. No. 60/693,922 filed Jun. 24, 2005.

### FIELD OF THE INVENTION

The present invention relates, in general, to a protective covering, and, more particularly, the present invention relates to protective pad that can be used over a seat in a car so that a pet does not scratch the seat or the door.

### BACKGROUND OF THE INVENTION

Pet owners, particularly dog owners love to travel with their pet; however, no one likes the hair, drips, drool, smudges and scratches left behind on a car's interior after traveling with such pet. While the beloved dog enjoys sticking his/her head out of the window of the automobile, the pets nails can quickly scratch or scrape the exterior paint of the car door. Further, dog hair or cat hair can become embedded in the upholstery and claws can puncture or severely damage leather, vinyl or even fabric interiors. Dirty paws can also mark the interior of the car. Most animals are well behaved enough in vehicles that kennels are not needed during travel, but interior and exterior protection is necessary when the animal rides along on the trip.

Thus, it would be advantageous if there were a product available which would enable pet owners to take their pet with them without the worry of lengthy clean up or damage to the interior or exterior of the car.

### SUMMARY OF THE INVENTION

The present invention provides an apparatus for protecting a vehicle against damage from a pet's nails at least one of scratching and/or shedding hair. Such apparatus includes a first member having each of a first predetermined shape, a first predetermined size, a first predetermined thickness and being substantially impermeable to such pet's nails. The first member extends over such vehicle's window ledge and downwardly a predetermined distance from such vehicle window ledge. Such distance is at least sufficient to prevent such pet's nails contacting such vehicle's paint. A second member is provided which has each of a second predetermined shape, a second predetermined size and a second predetermined thickness for preventing at least one of such pet's hair and wet and muddy paws from contacting a seat of such vehicle. There is a means engageable with a first predetermined edge of such first member and a first predetermined edge of such second member for securing the first member to such second member.

### OBJECTS OF THE INVENTION

It is, therefore, one of the primary objects of the present invention to provide a protective cover pad for protecting a seat of a car when riding with a pet.

Another object of the present invention is to provide a protective cover pad that will also fold over a window opening so that such door will not be scratched by such pet.

Still another object of the present invention is to provide a protective cover pad which includes a magnetic portion for covering a top half of a car door with the window open.

Yet another object of the present invention is to provide a protective cover pad that folds up for easy storage.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus according to an embodiment of the invention place on a rear seat of an automobile.

FIG. 2 is a perspective view of the apparatus shown in FIG. 1 with a first portion folded up.

FIG. 3 is a perspective view of the apparatus shown in FIG. 1 with a first portion folded over an open door window.

FIG. 4 is a perspective view of the apparatus shown in FIG. 3 seen from the exterior of the car showing the magnetic portion for holding such apparatus tight against the door.

FIG. 5 is a perspective view of the apparatus shown in FIG. 1 with the apparatus folded up inside he pouch for easy storage.

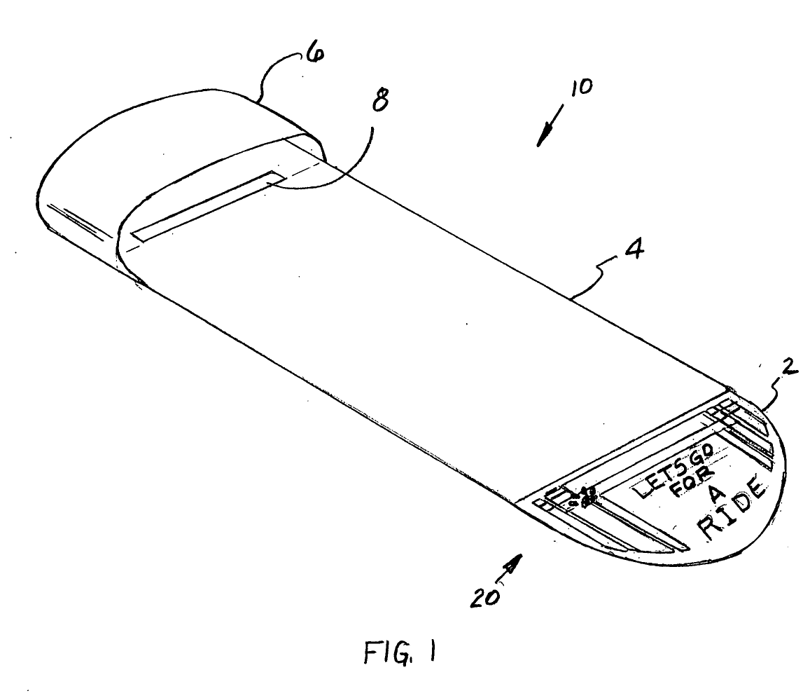

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for protecting a vehicle against damage from a pet's nails at least one of scratching and/or shedding hair. Such apparatus 10 includes a first member 2 having each of a first predetermined shape, a first predetermined size, a first predetermined thickness and being substantially impermeable to such pet's nails. The first member 2 extends over such vehicle's window ledge and downwardly a predetermined distance from such vehicle window ledge. Such distance is at least sufficient to prevent such pet's nails contacting such vehicle's paint. A second member 4 is provided which has each of a second predetermined shape, a second predetermined size and a second predetermined thickness for preventing at least one of such pet's hair and wet and muddy paws from contacting a seat of such vehicle. There is a means, generally designated 20, engageable with a first predetermined edge of such first member 2 and a first predetermined edge of such second member 4 for securing the first member 2 to such second member 4.

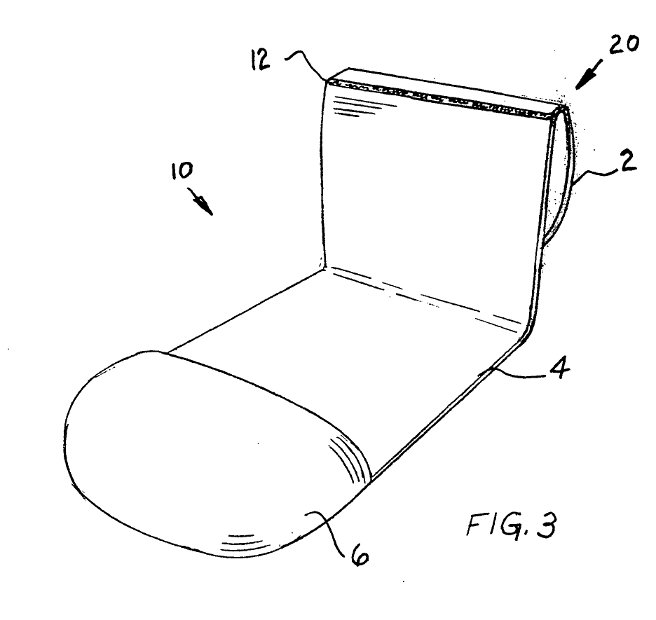

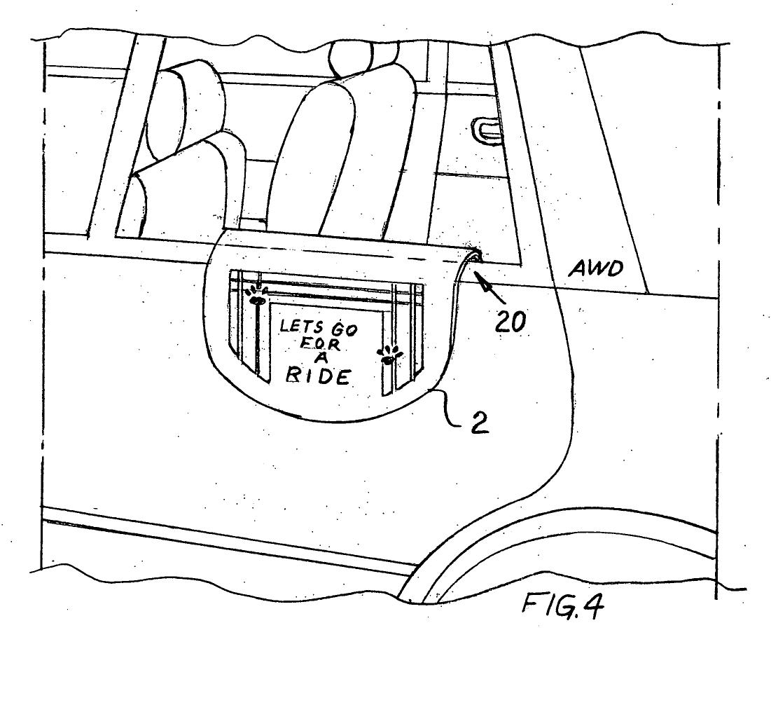

As seen in FIG. 3 such second member 4 can be folded intermediate the first predetermined end and a second predetermined end for permitting the second member 4 to fold up and cover an inside panel of a car door when such first member 2 extends over such vehicle's window ledge.

Such second member 4 further includes a pouch member 6 disposed on the second predetermined end of such second member 4. The pouch member 6 can be used to store the apparatus when the apparatus is not being used. In this way the apparatus is conveniently stored and can be kept in the trunk until used again. Such pouch member 6 also is used as a storage unit for storing pet supplies when the apparatus 10 is being used. The pouch can be sealed against the second member 4 to safely secure the pet supplies in the pouch 6. Such pouch 6 can be secured by means of hook and loop closures 8 (Velcro).

Such first member 2 is one of a magnetic member or a fabric member which contains a magnet therein for securing the first member 2 to such exterior portion of such vehicle's door when the first member 2 extends over such vehicle's window ledge.

Such magnetic member is attached to said second member 4 by means of a hook and loop attachment. Similarly such means 20 that is engageable with a first predetermined edge of the first member 2 and a first predetermined edge of the second member 4 for securing such first member to such second member is a hook and loop attachment 12.

The second member 4 of the apparatus is made of at least one of fabric and plastic. It is presently preferred that such second member be made of fabric.

The predetermined size of such second member 4 is sufficiently wide enough to extend substantially a depth of a car seat so the pet doesn't really contact the seat portion when the apparatus 10 is in place.

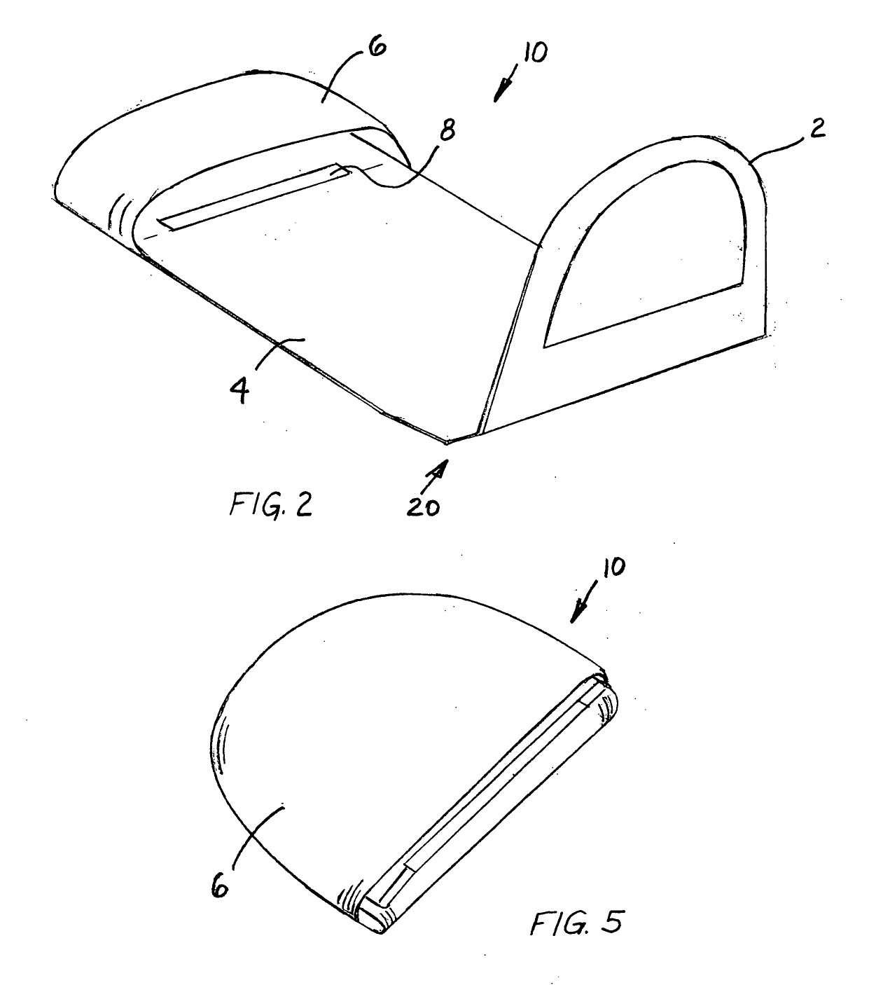

As seen in FIGS. 2 and 5 the predetermined shape of the first member 2 is substantially rectangular with arcuate corners disposed on a second edge thereof.

Thus, the present invention provides an oblong design with two separate components. The first portion of the apparatus consists of a large magnetic piece that covers the top half of the exterior of a car door when the window is open to permit the dog to have its head and paws outside. This portion protects the exterior paint from scratches. For convenience in order to clean and store the unit, a velcro (hook and loop) strip is used to connect the magnet portion to the second portion (fabric portion) that protects the interior of the door and the seat. The fabric covers the door panel and continues across the seat to prevent hair or fur accumulation. It also will prevent claw marks, punctures or dirty paw prints on the seat. The fabric portion contains a pouch member which can be sealed by Velcro and in which one can safely store pet supplies. When not in use the apparatus can be conveniently folded into the pouch for easy storage and kept inside the vehicle. It is within the concept of the invention that such apparatus can be made from a variety of materials and be made in a variety of colors. Further, if desired the magnetic portion can be personalized with the pet's name or with some other marking. The apparatus will fit into any car and can be used to safeguard any vehicle from pet damage.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. An apparatus for protecting a vehicle from a pet scratching and shedding hair, said apparatus comprising:
(a) a first member having each of a first predetermined shape, a first predetermined size, a first predetermined thickness and substantially impermeable to such pets nails, said first member extending over such vehicle's window ledge and downwardly a predetermined distance from such vehicle window ledge which is at least sufficient to prevent such pet's nails contacting such vehicle's paint;
(b) a second member having each of a second predetermined shape, a second predetermined size and a second predetermined thickness for preventing at least one of such pet's hair and wet and muddy paws from contacting a seat of such vehicle;
(c) a means engageable with a first predetermined edge of said first member and a first predetermined edge of said second member for securing said first member to said second member.

2. The apparatus, according to claim 1, wherein said second member can be folded intermediate said first predetermined end and a second predetermined end for permitting said second member to fold up and cover an inside panel of a car door when said first member extends over such vehicle's window ledge.

3. The apparatus, according to claim 2, wherein said second member further includes a pouch member disposed on said second predetermined end.

4. The apparatus, according to claim 3, wherein said pouch member is used for storing said apparatus when not in use.

5. The apparatus, according to claim 1, wherein said first member is one of a magnetic member and a fabric member containing a magnet for securing said first member to such exterior portion of such vehicle's door when said first member extends over such vehicle's window ledge.

6. The apparatus, according to claim 5, wherein said magnetic member is attached to said second member by means of a hook and loop attachment.

7. The apparatus, according to claim 1, wherein said means engageable with a first predetermined edge of said first member and a first predetermined edge of said second member for securing said first member to said second member is a hook and loop attachment.

8. The apparatus, according to claim 1, wherein said second member is made of at least one of fabric and plastic.

9. The apparatus, according to claim 8, wherein said second member is made of fabric.

10. The apparatus, according to claim 1, wherein said predetermined size of said second member is sufficiently wide enough to extend substantially a depth of a car seat.

11. The apparatus, according to claim 1, wherein said predetermined shape of said first member is substantially rectangular with arcuate corners disposed on a second edge thereof.

12. The apparatus, according to claim 3, wherein said pouch member can also be used as a pocket for storing pet supplies.

13. The apparatus, according to claim 12, wherein said pouch member can be sealed so as to safely store such pet supplies.

14. The apparatus, according to claim 13, wherein said pouch member is sealed by means of hook and loop closure.

15. The apparatus, according to claim 1, wherein said second predetermined shape is substantially oblong.
